(19) United States
(12) Patent Application Publication
(10) Pub. No.: US 2014/0068247 A1
(43) Pub. Date: Mar. 6, 2014

(54) SECURITY DEVICE ACCESS

(71) Applicant: MOOSE LOOP HOLDINGS, LLC, (US)

(72) Inventors: Ken R. Davis, Salt Lake City, UT (US); Joseph A. Turner, Salt Lake City, UT (US); Fraser M. Smith, Salt Lake City, UT (US)

(73) Assignee: MOOSE LOOP HOLDINGS, LLC, Salt Lake City, UT (US)

(21) Appl. No.: 13/708,981

(22) Filed: Dec. 8, 2012

Related U.S. Application Data
(60) Provisional application No. 61/569,599, filed on Dec. 12, 2011.

(51) Int. Cl. G06F 21/60; H04L 29/06

(52) U.S. Cl. CPC G06F 21/602; H04L 63/0428
USPC 713/155; 713/182

(57) ABSTRACT

Technology is described to control a security device providing access to a restricted resource. The method can include generating a plurality of security access codes at a security locking device using at least one pre-configured symmetric key. The access codes may each be valid from predefined start times for varying time intervals. In a further operation, a candidate access code can be generated at a control server, using the same pre-configured symmetric key. The candidate access code from the control server can be provided to the security locking device. The security locking device can unlock when the candidate access code corresponds to at least one of a valid security access codes on the security locking device.

### PRIORITY CLAIM

Priority is claimed to U.S. Provisional Patent Application Ser. No. 61/569,599, filed Dec. 12, 2011, which is hereby incorporated herein by reference in its entirety.

### BACKGROUND

Many service providers are often hired to access to a location where a service is or installation is to be performed. Such properties are often protected using security systems or locking devices to keep intruders out. In order to access the security system or locking device, the service provider can use a physical key, a key code, or a digital locking system (e.g, access card, RFID—radio frequency identifier, magnetic lockbox, etc.) to access the security system. Similarly, users may also desire to access a storage device (e.g., compartment, safe, etc.) or vehicle and this may also be performed using an access code or key for the security system associated with the storage device or vehicle.

Where physical keys are distributed to access the security system, these keys may often be lost or misplaced. In one problematic example, the keys can be issued to users or service providers who are later fired or discharged. Replacing keys or rekeying security systems can be relatively expensive and the replacement process is typically inconvenient.

While key codes may not be lost, the key codes may need to be updated on a regular basis to maintain a high level of security. However, changing the key code on a regular basis may be overlooked by owners of the security system because changes to the key code may be time consuming and may even include associated locksmith expenses.

Digital locking systems are similarly expensive to instrument, maintain and configure. For example, digital locking and digital security systems frequently use installed power to operate the locking device and network connectivity for managing the locking device. Furthermore, when an access card is lost for a digital security system, replacing the access card can be expensive and often represents a temporary vulnerability to the security system until the misplaced access card is noticed and the digital locking device reprogrammed to no longer consider that access card valid.

### BRIEF DESCRIPTION OF THE DRAWINGS

FIG. 1A is a block diagram illustrating an example of a system for pre-configuring a security locking device using a master server.

FIG. 1B is a block diagram illustrating an example of a system for controlling access to a restricted resource and for pre-configuring a control server.

FIG. 2 is an example block diagram illustrating a system for controlling access to a restricted resource via a security locking device.

FIG. 3 is a chart illustrating an example of time interval relationships for a plurality of access codes.

FIG. 4 is a block diagram illustrating an example of clock synchronization of the security locking device and the control server using an atomic time broadcast.

FIG. 5 is a block diagram illustrating an example of a candidate access code that may be received by a human, who acts as a human delivery agent.

FIG. 6 is a block diagram illustrating a system capable of generating and using a secure audit log.

FIG. 7 is a flowchart illustrating a method to control a security device providing secure access to a restricted resource.

FIG. 8 is a block diagram illustrating an example method for protecting data on a security locking device.

FIG. 9 is block diagram illustrating an example of a computing device for providing secure access to a restricted resource.

### DETAILED DESCRIPTION

A technology is described that can securely control a security locking device to limit access to a restricted resource or restricted area. The security locking device may control a mechanical lock, electronic lock, magnetic lock or another type of locking mechanism. The security locking device may be pre-configured to generate security access codes using a symmetric encryption key and/or cryptographic primitives received at configuration time from a master server. The cryptographic primitives may include cryptographic transformation algorithms, additional key matter, hashes, seeds, time stamps, time values, patterns or methodologies. In addition, the security locking device may also be able to receive a candidate access code generated using a copy of the same symmetric encryption key, and/or cryptographic primitives that are located on control server. When the candidate access code is determined to be derived from the same symmetric key as the security access code, then the locking mechanism associated with the security locking device may provide access to the desired resource.

The security locking device may be pre-configured to generate security access codes for multiple time intervals (i.e., multiple lengths of time). More specifically, the security locking device may be pre-configured to anticipate a large number of possible time intervals and/or a large number of unique users. The technology may accommodate any number of unique users without knowing any specific information about users who may access the device in the future. More specifically, the technology does not need to know any user names, personal information, or user specifics for users who will be provided later access to the security system. This is in contrast to many other electronic locking systems that use access cards or RFID where a physical card may be assigned to a known and named user.

Individual access code may be provided for each time interval, user, or unique purpose for the access code. For example, access codes may be generated simultaneously using the same symmetric encryption key on the security locking device and the control server at example time intervals of 5 minutes, 15 minutes, 1 hour, 3 hours, 6 hours, 12 hours, 24 hours, 2 days, 3 day, 1 week, 2 weeks, 4 weeks, 1 month, 3 months, one year or any other desired time interval. As a more specific example, the time intervals can start at various dates and times such as Monday Dec. 5, 2012 at 8:00 am, 8:05 am, 8:10 am, etc. In addition, multiple access codes may be generated for each of the multiple time intervals and/or multiple interval start times. Each of interval start times may also have an interval end time to form an overall time interval. This may allow multiple users to access the security locking device during the same time interval or time period. Alternatively, each access code may have a unique purpose. For example, one access code may be assigned for each entry and one for each exit from a door. Alternatively, access codes may be designated as one time use codes, in which case, once the access codes are used (i.e., during a valid interval of time with a particular start time) the access codes cannot be used a second time.

The pattern and methodology for computing valid security access codes, for a given moment in time, is typically known in advance by the security locking device and the control server. This means that actual access code computation may be performed by the security locking device, when the lock is actually used, to verify that a supplied code is actually valid. This results in a reduced number of security access code computations and thus a reduction in electric power use and computational use, while enabling flexibility over a variety of time intervals for which security access codes may be valid. In an alternative configuration, the access codes may be continuously computed and used when a candidate access code is presented to unlock the security locking device.

As a result, the security locking device may be pre-configured to anticipate a large number of possible future access scenarios (e.g., time intervals, number of users, or unique purposes) that may be desired. This technology enables the issuance of multiple simultaneous access codes that have the same valid time interval or the issuance of multiple access codes that have differing valid time intervals. A typical security key system requires a priori knowledge of users, purposes, and valid access times, often by either (a) being connected to a network so that the security locking device can be reconfigured at any time to accommodate new user access, or (b) sharing a single code or key with many users, or (c) having several layers of keys (e.g. master key versus individual user key). In the case of this security locking device, many users can authenticate for many purposes to a single security locking device. Further, users, who were not anticipated in advance of the installation of the security locking device, may be granted codes by the control server without having to reprogram, reconfigure, or otherwise connect to the security locking device with configuration instructions.

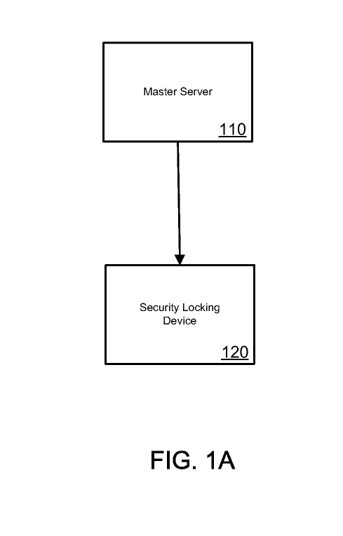

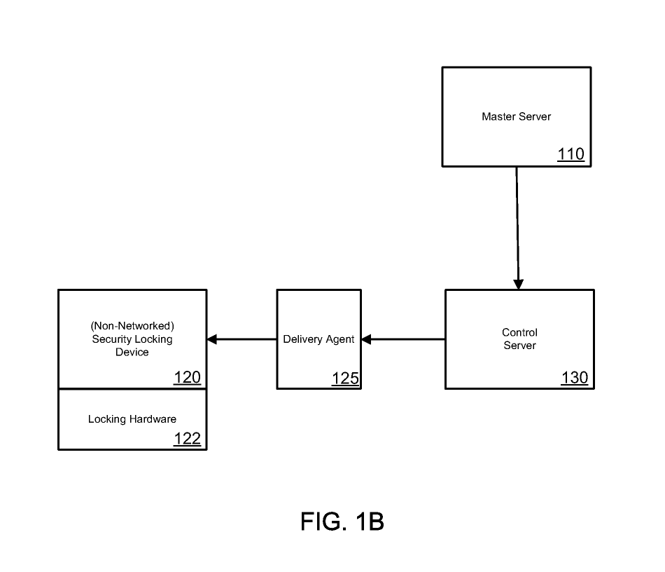

FIG. 1A illustrates a system for pre-configuring a security locking device 120 using a master server 110. The master server 110 can send a symmetric encryption key to the security locking device 120. The master server may also send additional cryptographic primitives along with the symmetric encryption key. The initial symmetric key and/or cryptographic primitives may be sent once to the security locking device 120 when the security locking device 120 is manufactured. At this point, the security locking device 120 may be fixed into a self-contained device that is not electronically networked with two or more other devices. This first symmetric key and/or cryptographic primitives can be used by the security locking device 120 to generate security access codes using a pre-established method or pattern. When an appropriate candidate access code (i.e., generated from the same symmetric key, and cryptographic primitives) is submitted to the security locking device 120, then the security locking device may be unlocked and access may be granted to a protected resource.

FIG. 1B illustrates a system for controlling access to a restricted resource. The system may include a non-networked security locking device 120 with locking hardware 122 and a control server 130 that provides candidate access codes to unlock the security locking device 102. Examples of a restricted resource may be a building, door, safe, or another structure or security device.

A self-contained or non-networked security locking device 120 can generate a plurality of security access codes using a pre-configured symmetric key and/or additional cryptographic primitives, including a pre-established method or pattern, received from the master server 110. The pre-configured symmetric key can be loaded into firmware or a hardware computing chip that may be integrated into the self-contained security locking device 120. An example of a symmetric key generation system that may be used is the RSA SecureID two factor key generation system. In addition, other schemes may be provided that enable the centralized management of quasi-two factor security tokens.

In a further example, the security locking device 120 and the control server 130 may generate the security access codes and candidate access codes, respectively, using the shared symmetric key and/or cryptographic primitives. While the security locking device 120 may have the symmetric key and time, the security locking device 120 may not know the seed, but the security locking device may know the method for generating the seed using the symmetric key and time value. In an alternative configuration, the security access code can be created using the symmetric keys and a pseudo-random code to generate shared access codes for time intervals. In yet another configuration, the access codes may be generated using the symmetric keys and a current time value as an input to the access code generation method. In yet another configuration, the access codes may not match directly, but only indirectly after a one-way transformation cipher, hash, such as a CRC (cyclic redundancy check), MD5 (message digest algorithm), SHA1 (secure hash algorithm), etc.

An initial transfer of the symmetric keys to pre-configure the control server 130 and the security locking device 120 may also take place in a secure manufacturing environment or using an asymmetric key exchange of the symmetric keys using public keys for the security locking device 120 and control server 130 that are known to the master server 110. The security locking device 120 and control server 130 may have their own respective private keys to decrypt the secure message and obtain the pre-configured symmetric key when the pre-configuration information is received by the security locking device 120 and control server 130. Because the security locking device may have no direct network connectivity, a device can be connected to the security locking device temporarily, during the manufacturing process, to facilitate the delivery of the symmetric key.

The self-contained security locking device 120 does not generally use network connectivity to function as described in this description. This non-networked aspect of the security locking device 120 means that the security locking device is not connected to a computer network using a networking communications protocol. Thus, the security locking device 120 does not connect to the Internet using a protocol such as TCP/IP. In addition, the security locking device may not connect to other devices over a wireless network such as a wireless mesh network or a Wi-Fi network. The term non-network or self-contained are defined herein as not connecting to two or more computers. In contrast, a direct connection to one other computer in short range physical proximity to the security locking device 120 is not considered networked for the present technology.

The lack of a network connection for the security locking device 120 may provide a greater level of security for the self-contained device. Since individuals who use or own the self-contained security locking device 120 may use the self-contained security locking device 120 to protect a valuable location or valuable objects, then the lack of network ability means that the self-contained security locking device 120 may not be remotely compromised by a network hacker. Any access attempts to the security locking device 120 can be recorded and the use of the candidate access code can make known the identity of the user who was originally issued the candidate access code. Limiting an attack on the physical security locking device to users who physically approach the device can significantly reduce the possibility of attacks on the security locking device 120.

The lack of a network connection for the security locking device 120 may significantly reduce power use, meaning that the device may not need to be connected to a power grid at all, and can obtain the power used either from a battery, kinetic motor, turning a door handle, or solar cell. This may significantly reduce installation and ongoing power costs for the device.

The lack of a network connection for the security locking device 120 may eliminate the costs of cell phone or other subscription based internet or network connectivity. These costs can be prohibitive if used on every security locking device of apartments at a large apartment complex. For example, a $20 per month cell services connection for 200 apartment units may cost $4,000 per month, none of which is used for the present technology to operate as described.

Locking hardware 122 may be configured to receive locking and unlocking instructions from the self-contained security locking device 120. For instance, the locking hardware 122 may include a bolt lock, latch, or another type of locking mechanism that is driven with a motor or servo mechanism. The locking device may lock a door for a building, a room, a storage garage, storage container, or another space a user may enter. The locking device may also lock other devices such as a safe, a vehicle, or any other resource that is desired to be protected.

The control server 130 may generate a candidate access code using the pre-configured symmetric key (with the possible inclusion of cryptographic primitives). The locking hardware 122 may be unlocked when the candidate access code received by the self-contained or non-networked security locking device 120 is determined to have been generated using the same symmetric key (with the possible inclusion of cryptographic primitives) as the security access code for the matching time period. In other words, the candidate access code may be deemed as matching the security access code when a determination has been made that the candidate access code and the security access code are generated from a same symmetric key using the same generation methods. The method for comparing the security access code and the candidate access code may be initially known by the master server 110 and this method for comparing the access codes may be provided to the security locking device 120 and the control server 130 at pre-configuration time.

Access codes that have a one-time use may also be provided using the same generation methods described earlier. Such one-time access codes may be valid for one use during a defined time interval. In other words, a candidate access code may be invalid after just one use of the candidate access code or after the time interval passes. If a user tries to use the candidate access code a second time during the time interval, then the access code will not provide access. The one-time access codes may be an entirely separate set of security access codes and candidate access codes that the security locking device knows are usable just one time. To reiterate, once the one-time access codes are used, the access codes cannot be used a second time even if the access code submission is still within the valid interval after the valid start time.

A delivery agent 125 may be used to deliver the candidate access code received from a control server 130 to the self-contained security locking device 120. The delivery agent 125 may be a hardware device or a human agent. The delivery agent 125 may be a delivery agent device (e.g., a physical computing device) that obtains a single candidate access code from the control server 130 based on a desired access time after a user has been authenticated to the control server. As an end delivery example, the delivery agent device may be plugged into the self-contained security locking device 120 using wired connection such as a cable, a CAT 5 (Category 5) cable, a co-axial cable, null modem cable, a bus, a connector dongle, or another physical connection, and the delivery agent device may use a communications protocol to send the candidate access code to the self-contained security locking device 120 over the wired connection. Examples of a connection protocol that may be used can include a Universal Serial Bus, FireWire, or another type of communications format.

In another example, the delivery agent 125 can display an optical candidate access code on a screen of the delivery agent device and the self-contained security locking device 125 may have an optical scanner to capture a code from the delivery agent device 125. For example, the delivery device may present a bar code, 2D bar code, or symbolic code that can be captured by an optical scanner. The optical scanner may be a camera, laser scanner, or an infrared scanner.

The delivery agent device 125 may be a device such as, but not limited to, a laptop, a tablet, a mobile device, a cell phone, a smart phone, a hand held messaging device, a personal data assistant, an electronic book reader, a dongle, a USB thumb drive, or any device that may receive and provide the candidate access code from the control server 130 to the security locking device 120. The candidate access code may be valid for a specific time period to enable access to the security locking device 120.

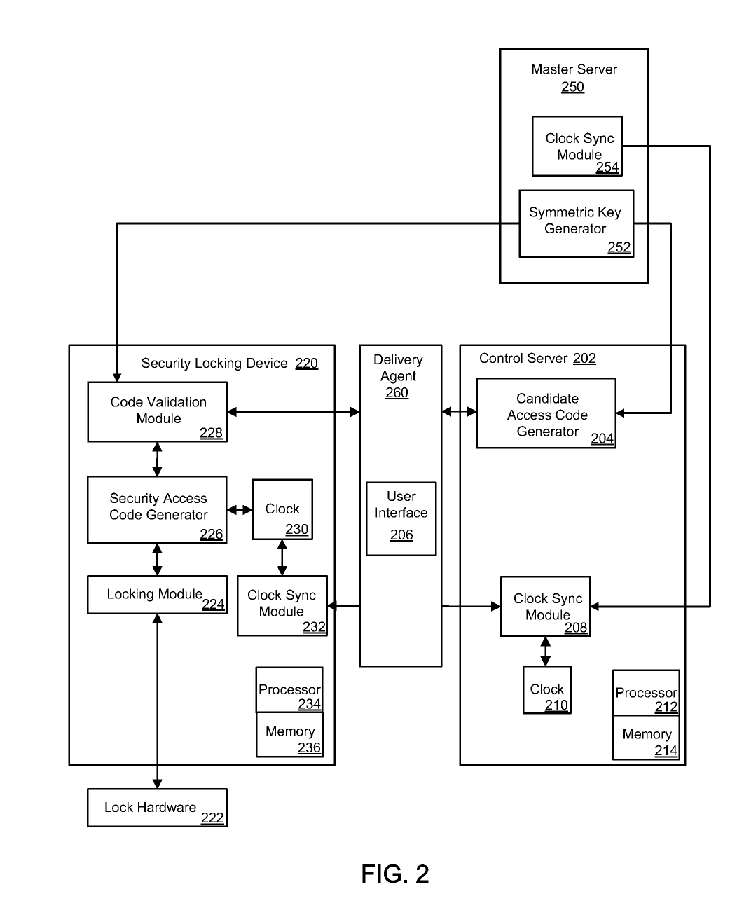

FIG. 2 is a block diagram illustrating a more detailed example of system for controlling access to a restricted resource via a security locking device. More detailed example views of the master server 250, control server 202, and security locking device 220 are provided.

The master server 250 may contain a symmetric key generator 252 to generate a symmetric key that is provided to the control server 202 and the security locking device 220. The master server 250 may also use an asymmetric key exchange technique to deliver the symmetric key to either the control server 202, the security locking device 220, or both. The symmetric key can be installed at the initial configuration time, such as at the time of manufacture or a one-time initialization. The configuration of the security locking device 220 is likely to be at a different time (e.g., hardware manufacture time) than the control server 202 (e.g., a server setup time). Since the security locking device may be non-networked, the symmetric key provided to the security locking device 220 is not expected to be changed. However, the symmetric key on the security locking device 220 might be updated by physically visiting the security locking device 220 and updating the software and firmware for the entire security locking device 220.

A security access code generator 226 in the security locking device 220 can be generating security access codes on a periodic basis, continuously, or as-needed. In addition, the candidate access code generator 204 on the control server 202 can be generating periodic candidate access codes for time intervals and start times that are the same as the time intervals and start times for the security access codes. The candidate access codes can be requested by a delivery agent 260 from the candidate access code generator 204. In one case, a user may access a user interface 206 on the delivery agent 260 to request the desired candidate access code. The candidate access code may be provided to the delivery agent 260 where the user has supplied the proper credentials and security clearance to the control server 202.

In one use case example, a service provider may be asked to access a security locking device 220 to gain access to a rental property in order to perform a service, such as a cleaning service. The service provider may be assigned to perform a task by a customer who owns or manages the rental property. Therefore, the service provider is authorized to receive a candidate access code to gain access to the rental property at the appropriate time interval to perform the work. In addition, if the service is assigned to the service provider through an automated task assignment system, the task assignment may be accompanied by a candidate security code for accessing the security locking device 220 in order to enter the rental property.

The code validation module 228 can compare the candidate access code and the security access code and determine whether the access codes are generated from the same symmetric key (e.g., the access codes match). If a match is obtained, then the locking module 224 can send instructions to the lock hardware 222 to open a lock or another security device.

The security locking device 220 and control server 202 may each include clocks 210 and 230 that may be used to track time intervals that security access codes and/or candidate access codes are valid. The clocks of the security locking device 220 and control server device 202 may be synchronized when the security locking device 220 and delivery agent device 260 (e.g., mobile device) communicate with each other. In one configuration, an initial clocking signal may be sent from the clock sync module 254 of the master server 250 to the clock sync module 208 of the control server. This initial clock signal may be sent over a network such as the internet. Further, the delivery agent 260 may obtain the clock sync signal from the control server when obtaining the candidate access code. Then, the delivery agent 260 may transfer a candidate access code to the security locking device 220, and the clock sync signal of the control server 202 may be sent to the clock sync signal module 232 of the security locking device 220. The synchronized clock signals may allow the security access code and the candidate access code to be compared during the time the generated security access codes are valid. If the candidate access code has been submitted during a valid time interval and the candidate access code matches with the security access code, then a successful candidate access code has been submitted and the locking hardware may be opened. The control server 202 and the security locking device 220 may each contain a processor 212, 234 and a memory device 214, 236 to assist in computing the operations described with respect to FIG. 2.

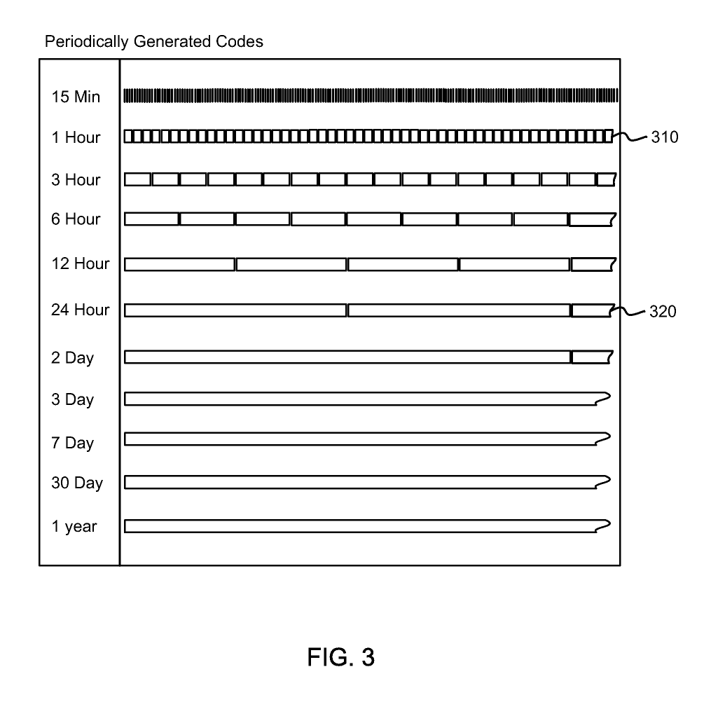

FIG. 3 is a chart illustrating a time interval relationship for a plurality of access codes. Both the control server and the security locking device may generate a plurality of access codes using the same single symmetric key. The security locking device may generate multiple security access codes and the control server may generate multiple candidate access codes. A user who desires to open a security locking device may be assigned a candidate access code that is valid for a specific period of time. When the candidate access code is provided to the security access device by the user or delivery agent during a time period when the candidate access code is valid, then the security locking device may open.

As illustrated in FIG. 3, the security locking device may have specific pre-determined time intervals for which at least one security access code may be active. For example, the security locking device may generate a new code for the 1 hour time interval 10 every hour at a specific time hourly epoch defined in advance. A time the new security access code may be generated is, for instance, on the hour every hour or at fifteen minutes after the hour, every hour. Similarly, for a 24 hour code 320, a new code may be generated each day at 12:00 midnight or at another selected time during each 24 hour period.

While regular generation of the access codes may occur, the generation of the access codes may occur at any pre-determined interval known to the security locking device and the control server as long as there are two or more access codes which are valid for separate time intervals with pre-determined time interval lengths. For example, a pseudo-random pattern may be used to determine how long selected access codes may be valid.

In addition, two or more of the access codes may be valid from separate start times. This can be seen where hourly access codes can start each hour and the weekly access code will begin each Sunday, for example. This example also illustrates that two or more time intervals during which security access codes and candidate access codes are valid may have overlapping time intervals. In one example, there may 168 hourly codes in each week that overlap with the one weekly code for each week.

Alternatively, there may hourly codes that begin at 5 to 15 minutes intervals around the hour. For example, if a new hourly access code becomes valid every 5 minutes, then 12 staggered but overlapping hour codes may be made available within an hour period. In this case, hourly access codes that are active during the time from 1 PM to 2 PM may have time intervals that overlap on themselves.

In yet another configuration, two or more time intervals during which generated security access codes are valid may have identical time intervals. In other words, there may be multiple access codes that are valid in a single time interval at any given time. For example, there may be 15 access codes that are valid during the entire hourly time interval from 3:00 PM to 4:00 PM. This allows the codes to be used by 15 different individuals or delivery agents for the defined hour.

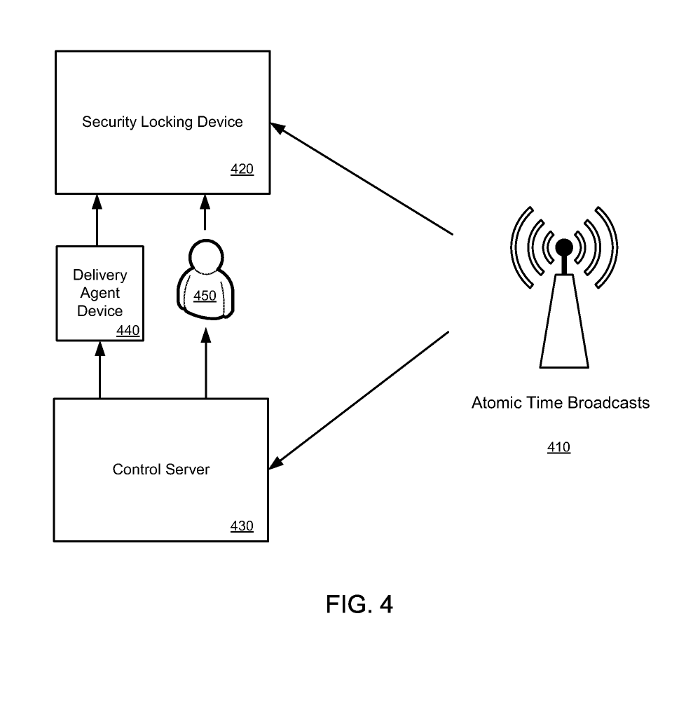

FIG. 4 illustrates that a synchronization of clocks in the security locking device 420 and the control server 430 may be performed using an atomic time broadcast 410 sent using low frequency RF (radio frequency). Low frequency atomic time broadcasts 410 allow radio clocks to depend on coded time signals from a radio station. A radio clock or radio-controlled clock is a clock that is synchronized by a time code bit stream transmitted by a radio transmitter connected to a time standard such as an atomic clock. Such a clock may be synchronized to the time sent by a single transmitter, such as many national or regional time transmitters, or may use multiple transmitters, like the Global Positioning System. These systems may be used to set clocks for the security locking device 420 and the control server 430. One example of a low frequency radio signal is the radio frequency signal sent at 60 kHz from Fort Collins, Colo. that is capable of being received in most of the United States mainland.

The clocks of the security locking device 420 and the control server 530 may receive the low frequency atomic time broadcasts and so their internal clocks may be synchronized using the radio frequency broadcasts. In one example configuration, the low frequency atomic time broadcasts or the synchronized time may be used to seed increments of the security access code and candidate access code. For example, a group of the security access codes and candidate access codes may be seeded using a combination of the symmetric key and the synchronized time. Since both the security locking device 420 and the control server 430 may have the same synchronized time, the security locking device 420 and control server 430 may generate the matching access codes.

In an additional configuration, the security access codes and candidate access codes can be compared with a time from the low frequency atomic time broadcasts to determine whether the clock of the security locking device is out of sync.

In one example configuration, the security locking device 420 may also contain a cellular modem and the security locking device may receive a current time via a cellular network directly. However, data delivery via the cellular network may be disabled to protect against hacking In a further configuration, a delivery agent device 440 may be used to provide a time to the security locking device 420. As an example, a delivery agent device may be a cellular phone that has a current time from a cellular network, and the delivery agent device may provide that current time to the security locking device 420 via a local wireless or local wired direct connection.

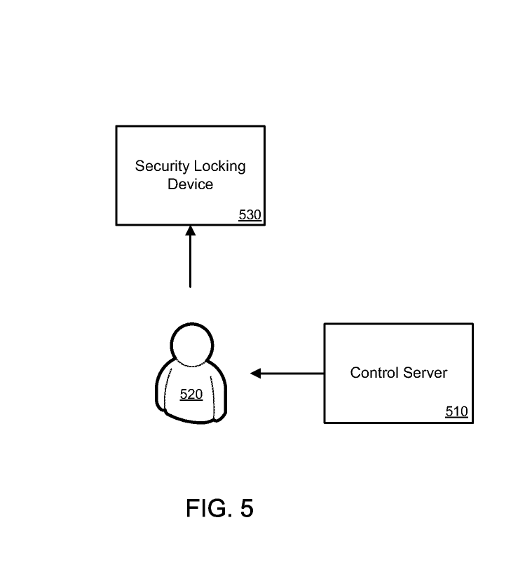

FIG. 5 illustrates that a candidate access code may be received from a control server 520 by a human who is acting as a delivery agent 520. The human delivery agent can enter the code into the security locking device 530 using a keypad, touch interface, or other user interface which in turn may unlock a mechanical or electronic locking device when a valid candidate access code is presented during the correct time interval. For example, a magnetic lock or a deadbolt lock may be opened.

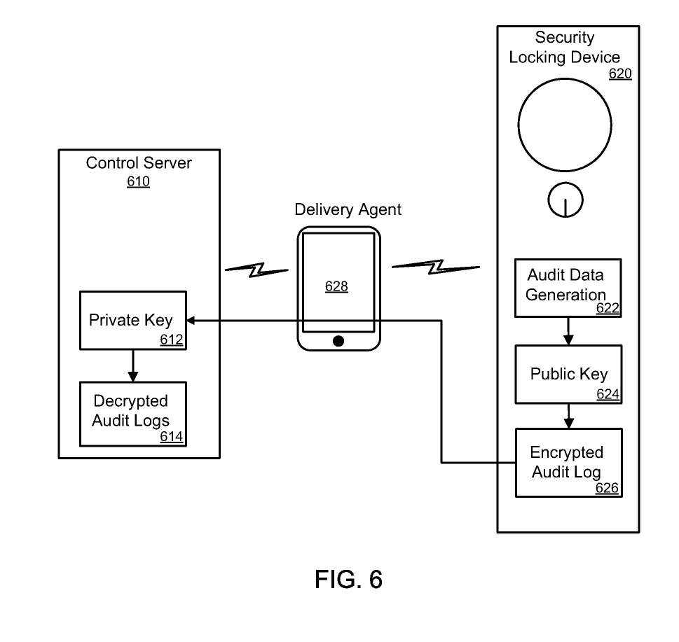

FIG. 6 illustrates a system capable of generating a secure audit log on the security locking device 620. The system may include a non-networked security locking device 620 to generate a plurality of security access codes. The security access codes may be valid from a predefined start time and for a predefined time interval. For example, the security locking device 620 may include a locking device (e.g., a deadbolt lock) on a door and the lock may have a doorknob and a keyhole for a mechanical key to also open the locking device.

A control server 610 may generate a candidate access code to send to the non-networked security locking device 620. As discussed before, when the candidate access code and the security access code match on the security locking device 620, then the locking mechanism may be opened. When such security access events or other events are triggered, the security locking device 620 may generate audit data using an audit data generation module 622. For example, the security access events may include a record of what candidate keys were submitted, the time the candidate keys were submitted, whether the candidate keys were successful or not, clock syncing and other events. In addition, the audit data generation module 622 may also contain a logging module to log an identity of a delivery agent which interacts with the security locking device 620 and/or presents a candidate security code. A list of users accessing the security locking device may be logged by identifying the candidate access code assigned to the user accessing the security locking device 620. While the security locking device 620 may not be able to identify the users, when the audit log information is transferred back to the control server 610, the candidate access code can be used to identify a user or delivery agent that the candidate access code was assigned to.

Each recorded event can be encrypted using a public key 624 and the encrypted information can be stored in an encrypted audit log 626. Each event for the security locking device may be encrypted individually as the events are created or all the events can be stored as unencrypted data and encrypted as a batch when the information from the audit log is requested to be transferred or downloaded.

As discussed earlier, a delivery agent 628 or delivery device may provide the candidate access code to the security locking device 620 to unlock the security locking device 620 when the security access code and the correlated access code are verified on the security locking device. In addition, when the delivery agent 628 is connected to the security locking device 620, the encrypted audit log 626 may be transmitted via the delivery agent 628 on to the control server 610. The delivery agent 628 may be connected to the security locking device using a wired connection such as a USB (Universal Serial Bus) connection or another temporary physically wired connection. In another connection configuration, the delivery agent 628 may be connected to the security locking device 620 using a temporary short range wireless connection such as an infrared (IR) connection, near field connection, Bluetooth connection, a Wi-Fi connection or another similar short range wireless connection. The control server 610 may have private key 612 used to decrypt the audit logs that are received.

The audit logs can then be stored in a data store for the decrypted audit logs 614. The term “data store” may refer to any module, device or combination of devices capable of storing, accessing, organizing, and/or retrieving data, which may include any combination and number of relational databases, object oriented databases, data storage devices, data warehouses, flat files, or data storage configurations. The storage system components of the data store may include storage systems such as a volatile or non-volatile RAM, optical media, or hard-drive type media.

The public key 624 and the private key for protecting the audit log may have been received from a key-generating server (not shown) to provide the keys for encrypting and decrypting the audit log information. The keys for protecting the audit log information can be separate from than the keys used for accessing the security locking device 620.

For example, a smart phone 628 may have an audit logging application installed on the smart phone. The smart phone may then be physically connected to (e.g., plugged into) the security locking device 620, and this physical connection may automatically cause the audit log data to be uploaded to the control server 610. Once the audit log data is decrypted, customers or users may be able to provide proper credentials to login and view the customer's own relevant data from the decrypted audit logs 614 on the control server 610.

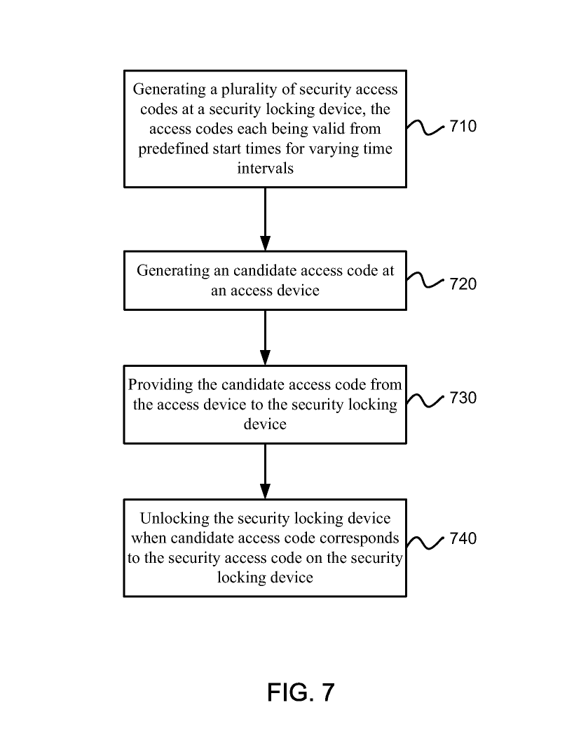

FIG. 7 illustrates a method to control a security device providing access to a restricted area or a restricted resource. In one case, the method may be used for accessing a door lock or another type of security lock.

A plurality of security access codes may be generated at a security locking device, as in block 710. The security access codes may be generated using at least one pre-configured symmetric key. The security access codes may each be valid starting at predefined start times for varying time intervals. For example, at any point in time, security access codes may exist that are valid for multiple time intervals. One or more individual access codes may be valid for a 15 minute interval, 30 minute interval, 1 hour interval, 3 hour interval, 6 hour interval, 12 hour interval, 1 day interval, or another interval before the access code expires. In addition, the system may have multiple access codes that are valid at one time for a specific interval. Multiple codes may be valid for each time interval for which access codes are being generated or multiple codes may be valid for time intervals that are used frequently such as 1 day or 3 day intervals. Thus, in one example, the security locking device may have 2-50 or more security access codes that may be valid for the one day interval.

In an example use case, a security locking device may be used for a time leased meeting room space that does not employ an attendant for each meeting room. If 15 people are attending a 1 day meeting in a room locked by the security locking device, each of the meeting attendees may receive a one day code for attending the meeting. The security access codes will expire after the one day which corresponds to the end of the meeting.

A candidate access code may also be generated at a control server, as in block 720. The candidate access code can be generated using the same pre-configured symmetric key as provided to the security locking device. In some examples, the control server is a networked server that can communicate the candidate access code to other computing devices networked with the control server. The control server may be networked over a cellular phone network, the internet, a wide area network (WAN) or another type of network.

The candidate access code may be provided from the control server to the security locking device, as in block 730. The candidate access code can be provided from the security locking device to the security locking device via a delivery agent. For example, the delivery agent may be a mobile computing device (e.g., a cell phone) or delivery agent device that receives the candidate access code from the control server. The computing device may supply the candidate access code to the security locking device via a wired connection or an infrared connection. Alternatively, the security locking device may include a mechanical keypad or a touch screen (e.g., write the code with finger/stylus or touch a keypad) that allows a user of the delivery agent device to enter the candidate access code into the security locking device.

For a security locking device that has a form of keypad entry, the security access code may be printed on a piece of paper or in another tangible format for a human delivery agent and this may allow the human delivery agent (e.g., user) to view the code and enter the code into the security locking device. Similarly, where the human delivery agent can view the security access code, then the human delivery agent may speak the access code to the security locking device. Because the entry mechanism for entering the security access code into the security locking device is not networked, then the device may be somewhat more resistant to hacking because an attacker who wants to access the device is physically present to attack the device.

In another configuration, the security access code can be provided from the delivery agent device to the security locking device using a wireless connection link that is a direct wireless connection between the delivery agent device and the security locking device, but the security locking device does not connect to any computer network with two or more other computing nodes. For example, the wireless communication link may use Radio-Frequency Identification (RFID), infrared, Bluetooth, Near Field Communications (NFC), or Wi-Fi.

The delivery agent device (e.g., a smart phone) may be configured to report back time and identification information to the control server via the cell network (encrypted or not, as desired) regarding when a delivery agent device presents the candidate access code to the security locking device. Reporting the identity of the user who submits the candidate access code to the security locking device may avoid the need to store data about who accesses the security locking device, since each access may automatically provide the desired record.

The security locking device can be unlocked when the candidate access code corresponds to at least one of the valid security access codes on the security locking device, as in block 740. In other words, the security access code and the candidate access code are determined to correspond or match with each other when the codes have been generated using the same symmetric key for the same time interval that is still valid.

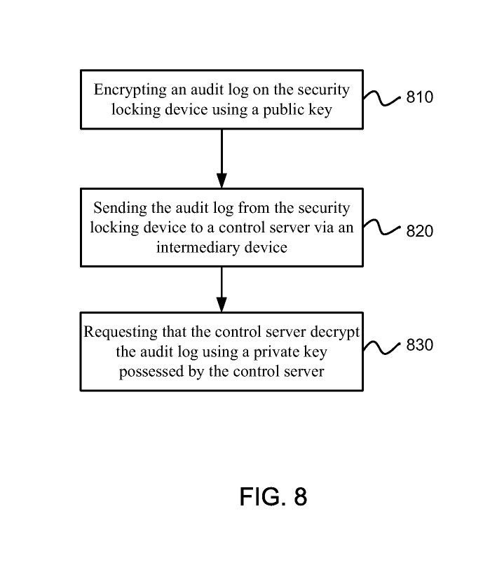

FIG. 8 illustrates a method for protecting data on a security locking device. An audit log may be encrypted on the security locking device using a public key, as in block 810. The audit log may represent events regarding the presentation of candidate access codes, the matching of candidate access codes with security access codes, and other security events on the security locking device.

The audit log may be sent from the security locking device to a control server via an intermediary device, as in block 820. The intermediary device may be a delivery agent device or another mobile computing device that can download the audit log via a wired or wireless connection for subsequent transfer to the control server. The audit log may be downloaded onto the delivery agent device using Bluetooth, Wi-Fi, Near Field Communication (NFC), or Radio-Frequency Identification (RFID).

The control server may be requested to decrypt the audit log using a private key possessed by the control server, as in block 830. A service provider may access data in the audit log on the control server associated with the service provider. For example, if a user desires to view the security locking devices the user has accessed, then the user may query about such information stored on the control server. Access to information on security locking devices created by other users may be blocked, if desired.

Obtaining the audit log may also be viewed from the perspective of the control server. In some cases, the download of the audit log may be initiated by the control server. An audit log on the security locking device may identified that has been encrypted using a public key. The audit log data may be encrypted on the security locking device as each audit transaction is created and the plain text copy of the audit log data may be purged.

The audit log may then be transferred from the security locking device to a control server via an intermediary device under direction of the control server. The audit log may be decrypted at the control server using a private key possessed by the control server. An end user may be allowed to access audit log data that is encrypted on the security locking device and moved to or decrypted by the control server.

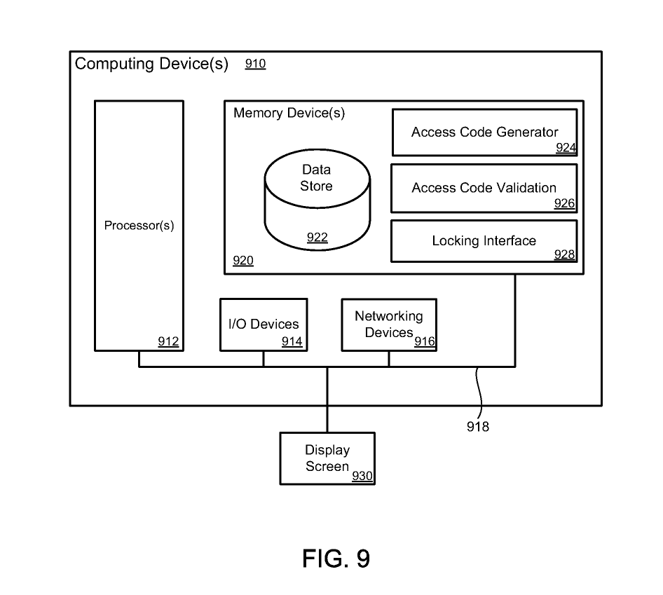

FIG. 9 illustrates a computing device 910 on which modules of this technology may execute. A computing device 910 is illustrated on which a high level example of the technology may be executed. The computing device 910 may include one or more processors 912 that are in communication with memory devices 920. The computing device may include a local communication interface 918 for the components in the computing device. For example, the local communication interface may be a local data bus and/or any related address or control busses as may be desired.

The memory device 920 may contain modules that are executable by the processor(s) 912 and data for the modules. Located in the memory device 920 are modules executable by the processor. For example, an access code generator 924, an access code validation 926, and a locking interface 928, and other modules may be located in the memory device 920. The modules may execute the functions as described earlier. A data store 922 may also be located in the memory device 920 for storing data related to the modules and other applications along with an operating system that is executable by the processor(s) 912.

Other applications may also be stored in the memory device 920 and may be executable by the processor(s) 912. Components or modules discussed in this description that may be implemented in the form of software using high programming level languages that are compiled, interpreted or executed using a hybrid of the methods.

The computing device may also have access to I/O (input/output) devices 914 that are usable by the computing devices. An example of an I/O device is a display screen 930 that is available to display output from the computing devices. Other known I/O device may be used with the computing device as desired. Networking devices 916 and similar communication devices may be included in the computing device. The networking devices 916 may be wired or wireless networking devices that connect to the internet, a LAN, WAN, or other computing network.

The components or modules that are shown as being stored in the memory device 920 may be executed by the processor 912. The term “executable” may mean a program file that is in a form that may be executed by a processor 912. For example, a program in a higher level language may be compiled into machine code in a format that may be loaded into a random access portion of the memory device 920 and executed by the processor 912, or source code may be loaded by another executable program and interpreted to generate instructions in a random access portion of the memory to be executed by a processor. The executable program may be stored in any portion or component of the memory device 920. For example, the memory device 920 may be random access memory (RAM), read only memory (ROM), flash memory, a solid state drive, memory card, a hard drive, optical disk, floppy disk, magnetic tape, or any other memory components.

The processor 912 may represent multiple processors and the memory 920 may represent multiple memory units that operate in parallel to the processing circuits. This may provide parallel processing channels for the processes and data in the system. The local interface 918 may be used as a network to facilitate communication between any of the multiple processors and multiple memories. The local interface 918 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A system to control access to a restricted resource, comprising:
a self-contained security locking device, independent of outside communication, the self-contained security locking device generating a plurality of security access codes using a pre-configured symmetric key;
a locking device configured to receive locking and unlocking instructions from the self-contained security locking device;
a control server to generate a candidate access code, using the pre-configured symmetric key, the locking device being unlocked when the candidate access code received by the self-contained security locking device is determined to have been generated by the same symmetric key as a security access code; and
a delivery agent to deliver the candidate access code received from a control server to the self-contained locking device.

2. The system as in claim 1, further comprising a delivery agent device to receive the candidate access code and submit the candidate access code to the self-contained security locking device.

3. The system as in claim 1, wherein the self-contained security locking device is non-networked.

4. The system as in claim 1, wherein the self-contained security locking device and the control server receive the pre-configured symmetric key at configuration time to enable the independent generation of the plurality of security access codes and a plurality of candidate access codes.

5. The system as in claim 1, wherein the restricted resource is a building, a room, an apartment, an office, a garage, a locker or a vehicle.

6. The system as in claim 1, wherein the candidate access code matches the security access code within a valid time interval, when a determination has been made that the candidate access code and the security access code are generated from a same symmetric key.

7. A method to control a security device providing access to a restricted resource, the method comprising:
generating a plurality of security access codes at a security locking device using a pre-configured symmetric key, the access codes each being valid from predefined start times for varying time intervals;
generating a candidate access code at a control server, using the same pre-configured symmetric key;
providing the candidate access code from the control server to the security locking device; and
unlocking the security locking device when the candidate access code corresponds to at least one of a valid security access codes on the security locking device.

8. The method as in claim 7, wherein the security access code and the candidate access code are determined to have been generated using the same symmetric key for a time interval where the security access code is deemed to be valid.

9. The method as in claim 7, wherein the control server is a networked server.

10. The method as in claim 7, further providing the candidate access code via a delivery agent to the security locking device.

11. The method as in claim 10, further comprising a delivery agent that is a mobile computing device.

12. The method as in claim 10, further comprising a delivery agent that is a human.

13. The method as in claim 7, wherein the security locking device includes a keypad which is not connected to a computer network.

14. The method as in claim 13, further comprising receiving input at the keypad on the security locking device, the input including the candidate access code from the control server as entered by a human delivery agent.

15. The method as in claim 7, wherein providing the candidate access code to the security locking device, further comprises receiving the candidate access code at a delivery agent device, from the control server, and sending the candidate access code to the security locking device via a wireless communication link or a wired communication link.

16. The method as in claim 15, wherein the wireless communication link uses Radio-Frequency Identification (RFID), infrared, Bluetooth, Near Field Communications (NFC), or Wi-Fi.

17. The method as in claim 14, wherein the candidate access code is entered by the user during a time period during which the access code is valid.

18. The method as in claim 7, further comprising sending the candidate access code from the control server to the non-networked security locking device using a wired communication link.

19. The method of claim 7, wherein two or more of the candidate access codes are valid for separate time intervals with varying time interval lengths.

20. The method of claim 7, wherein two or more of the candidate access codes are valid from separate start times.

21. The method of claim 7, wherein two or more time intervals during which candidate access codes are valid have overlapping time intervals.

22. The method of claim 7, wherein two or more time intervals during which generated security access codes are valid have identical time intervals.

23. The method of claim 7, wherein the security locking device and control server include clocks used to track time intervals that candidate access codes are valid.

24. The method as in claim 23, wherein the clocks of the security locking device and a control server are synchronized when the security locking device and mobile device communicate with each other.

25. The method of claim 23, wherein the clock of the security locking device is synchronized using low frequency atomic time broadcasts.

26. The method as in claim 25, further comprising using the low frequency atomic time broadcasts to seed increments of the security access code and candidate access code.

27. The method as in claim 25, further comprising comparing the security access codes and candidate access codes with a time from the low frequency atomic time broadcasts to determine whether the clock of the security locking device is out of sync.

28. The method as in claim 23, further comprising sending the security locking device a current time via a cellular network using a delivery agent.

29. The method as in claim 7, further comprising logging a list of users accessing the security locking device by identifying the candidate access code assigned to the user accessing the security locking device.

30. The method as in claim 21, further comprising sending log data from the security locking device to the control server through a delivery agent device which has transacted with the locking security device.

31. A system to control a locking device providing access to a restricted resource, comprising:
a non-networked security locking device to generate a plurality of security access codes, the security access codes being valid from a predefined start time and for a predefined time interval;
a control server to generate a candidate access code to send to the non-networked security locking device;
a key-generating server to provide a shared symmetric key to the security locking device and control server at configuration time, the shared symmetric key being used in generating the security access code and candidate access code; and
a delivery agent to provide the candidate access code to the security locking device to unlock the security locking device when the security access code and the correlated access code are verified to be valid on the security locking device.

32. The system as in claim 31, further comprising a logging module to log the use of the candidate access code received from a delivery agent which interacts with the security locking device, and the candidate access code tracks the identity of the delivery agent when combined with information resident on the control server.

33. A method for protecting data on a security locking device, comprising:
encrypting an audit log, representing presentation of candidate access codes and security events, on the security locking device using a public key;
sending the audit log from the security locking device to a control server via an intermediary device; and
requesting that the control server decrypt the audit log using a private key possessed by the control server.

34. The method as in claim 33, further comprising enabling a service provider to access data in the audit log on the control server associated with the service provider.

35. The method as in claim 33, wherein sending the audit log further comprises downloading the audit log from the security locking device to the control server via a delivery agent device.

36. The method as in claim 33, wherein sending the audit log further comprises downloading the audit log onto the delivery agent device using Bluetooth, Wi-Fi, Near Field Communication (NFC), or Radio-Frequency Identification (RFID).

37. A method for protecting data on a security locking device, comprising:
identifying an audit log on the security locking device that is encrypted using a public key;
transferring the audit log from the security locking device to a control server via an intermediary device; and
decrypting the audit log at the control server using a private key possessed by the control server.

38. The method as in claim 37, further comprising encrypting audit log data on the security locking device as each audit transaction is created.

39. The method as in claim 37, further comprising enabling an end user to access audit log data that is encrypted on the security locking device and moved to and decrypted by the control server.

40. A method to control a security device providing access to a restricted resource, the method comprising:
generating a plurality of security access codes at a security locking device using a pre-configured symmetric key, the access codes each being generated using a pre-established pattern where multiple codes are valid at predefined start times and over a plurality of time intervals;
utilizing a control server to produce a candidate access code based on the same pre-configured symmetric key used on the security locking device and the same pre-established pattern for producing a code valid at the desired predefined start time and interval;
providing the candidate access code from the control server to the security locking device via a delivery agent; and
unlocking the security locking device when the candidate access code corresponds to at least one of a valid security access code on the security locking device.

41. The method as in claim 41, further comprising generating multiple codes that are valid at one predefined start time and each of the multiple codes is valid for a same time interval.

42. The method as in claim 42, wherein each of the multiple codes corresponds to an identified user.

43. The method as in claim 41, further comprising generating multiple codes that are valid at a predefined start time and selected multiple codes are valid over a multiple time length intervals.

44. The method as in claim 41, wherein the multiple codes are pre-configured to accommodate any number of pre-determined time intervals or any number of pre-determined of unique purposes.
